(19) United States
(12) Patent Application Publication
(10) Pub. No.: US 2026/0243344 A1
(43) Pub. Date: Aug. 20, 2026

(54) METHOD FOR TEACHING AT LEAST ONE LOCKING POSITION OF A BLOCKING ACTUATOR, COMPUTER PROGRAM, COMPUTER PROGRAM PRODUCT AND VEHICLE

(71) Applicant: Schaeffler Technologies AG & Co. KG, Herzogenaurach (DE)

(72) Inventors: Peter SENFT, Rieden (DE); Christian MEY, Maxhütte Haidhof (DE); Markus STRÖHLA, Wenzenbach (DE)

(21) Appl. No.: 19/161,801

(22) PCT Filed: Feb. 27, 2024
(86) PCT No.: PCT/EP2024/054889

§ 371 Date: Sep. 3, 2025

(30) Foreign Application Priority Data
Mar. 7, 2023 (DE) 10 2023 202 014.9

(51) Int. Cl. F16H 63/48; F16H 61/00; F16H 63/34

(52) U.S. Cl. CPC F16H 63/48; F16H 63/3466; F16H 2061/0087

(57) ABSTRACT

A method for teaching at least one locking position of a locking actuator relative to an element, which is to be locked and is able to be driven by way of electric motor, of a drivetrain of a vehicle. The locked element is pivoted clockwise until the locking element comes to a first stop against the locked element, and then counterclockwise until the locking element comes to a second stop against the locked element. First electromotive angle information concerning the recess, corresponding to the first stop, and second electromotive angle information concerning the recess, corresponding to the second stop, is recorded and electromotive angle information, corresponding to a central position of the recess, is ascertained from these two items of angle information.

### CROSS REFERENCE TO RELATED APPLICATIONS

This is a U.S. national stage of Application No. PCT/EP2024/054889 filed Feb. 27, 2024. Priority is claimed on German Application No. DE 10 2023 202 014.9 filed Mar. 7, 2023, the contents of which are incorporated herein by reference.

### BACKGROUND OF THE INVENTION

### 1. Field of the Invention

The disclosure relates to a method for teaching at least one locking position of a locking actuator relative to an element, which is to be locked and is able to be driven by way of electric motor, of a drivetrain of a vehicle.

The disclosure furthermore relates to a computer program and to a computer program product that respectively replicate this method, and to a vehicle comprising such a computer program or computer program product.

### 2. Description of the Related Art

Parking locks in which an electrically actuatable lever having what is known as a pawl tooth interacts with a gearwheel of a drivetrain in order to block or to lock the drivetrain are known. Mention will be made, for example, of document DE 10 2017 102 804 A1, which describes such a parking lock having a pawl mechanism.

Parking locks having a locking member or locking element that is able to be adjusted or moved in a straight line along a movement path are also known. Mention will be made, for example, of document DE 10 2019 110 384 A1, which describes such a parking lock comprising a locking bolt.

If a vehicle is parked in an inclined position, for instance due to a curb on which it is parked for example with only one tire on the ground, then tension arises in the drivetrain when such a parking lock is in a locked state, because the vehicle is supported by the parking lock. In such a state of the vehicle, a greater unlocking force to be applied by the locking actuator is required to unlock the parking lock, compared to a flat parking position of the vehicle.

### SUMMARY OF THE INVENTION

An object of the present invention is an improved unlocking process of such a parking lock and to improve a locking process of such a parking lock.

Disclosed is a method for teaching at least one locking position of a locking actuator—also called a parking lock—relative to an element, which is to be locked and is able to be driven by way of electric motor, of a drivetrain of a vehicle. The method includes:
A controller, which is connected to the locking actuator, initiating a lifting movement of a locking element of the locking actuator, in particular along a lifting axis, into a recess of the element to be locked,
The controller receiving a sensor signal indicating a locking position of the locking element in the recess,
The controller initiating clockwise electromotive pivoting of the locked element until the locking element comes to a first stop against the locked element and until a definable electromotive deactivation torque, at which the pivoting is interrupted, is reached,
The controller receiving first electromotive angle information concerning the recess, corresponding to the first stop,
The controller initiating counterclockwise electromotive pivoting of the locked element until the locking element comes to a second stop against the locked element and until the definable electromotive deactivation torque, at which the pivoting is interrupted, is reached,
The controller receiving second electromotive angle information concerning the recess, corresponding to the second stop,
The controller ascertaining electromotive angle information, corresponding to a central position of the recess, from the first and second electromotive angle information concerning the recess.

A locking position of the locking actuator is understood here to mean one of numerous possible positions of the locking element in which the locking element is in an extended or disengaged or deflected state in a recess of an element to be locked, after it has been moved into the recess in a lifting movement, for instance in an axial lifting movement along a lifting axis. This multiplicity of positions of the locking element is caused by mechanical play between the locking element and the element to be locked in the circumferential direction of the locking actuator or of the element to be locked, and also by an elasticity on which the locking mechanism between the locking element and the element to be locked is based, as a result of which, due to loading that arises and acts on the locking mechanism, a corresponding position of the locking element relative to the element to be locked reaches a stop position in which the element to be locked stops against the locking element on account of the loading.

The first and second stop position described above may also be referred as a so-called locking position of the locking element.

Knowing said central position enables a force-optimized or force-free locking or engagement process and unlocking or disengagement process for such a locking actuator, in which a force effort to be applied by the locking actuator to actuate the locking element is minimal or as small as possible.

Knowing this central position, it is accordingly possible, by way of electric motor, to align a drivetrain that is subject to force or tensioned due to the inclined position of a parked and locked vehicle, as mentioned at the outset, such that the locking element is able to be unlocked in force-optimized or force-free fashion. Consideration may also be given at this juncture for example to a parking situation in which a vehicle is parked on a road with an incline or gradient. In a situation such as this as well, the vehicle is supported by the locking device or parking lock, namely on account of a downhill slope force that acts on the vehicle and, as such, attempts to move the vehicle.

Knowing this central position also makes it possible to be able to design such a locking actuator to be as small as possible or highly compact in terms of construction, so as to be able to save on installation space for the locking actuator. This is also accompanied by simplification of installation effort for such a locking actuator.

Knowing this central position also allows for coarser manufacturing tolerances of components of the drivetrain, because such manufacturing tolerances are able to be compensated for by the teaching method. Knowing this central position therefore also enables cost savings when manufacturing such components.

It is additionally proposed for the central position, thereby taught, of the recess to be used to infer the individual central positions of the other recesses of the element to be locked. Consideration may be given here for example to the tooth gaps in a gearwheel to be locked or a shaft section to be locked, in which a locking element of correspondingly complementary design engages or is able to engage.

It is proposed here for the teaching method to be initiated in response to a vehicle system request.

In addition or as an alternative, the teaching method may also be initiated in response to a driver request.

Also proposed are a computer program for performing the method described above and a computer program product comprising program code means that are stored on a computer-readable data carrier in order to perform the method described above when the program code means are executed on a computer.

Also proposed is a vehicle comprising a computer program or a computer program product of the type described above.

In this case, a vehicle should be understood to mean any type of vehicle or motor vehicle that is operated by way of electric motor, but in particular passenger cars and/or utility vehicles in the form of electric or hybrid vehicles. These may be semi-autonomous or fully autonomous vehicles.

The invention will be explained in detail below with reference to the illustrations in the figure. Further advantageous developments of the invention will become apparent from the dependent claims and the following description of preferred embodiments. For this purpose, in a single figure:

### BRIEF DESCRIPTION OF THE DRAWING

The Figure schematically shows different positions of a locking element relative to a locked, electric motor-driven element.

### DETAILED DESCRIPTION OF THE PRESENTLY PREFERRED EMBODIMENTS

The Figure illustrates—for the sake of simplicity—using two pentagons, three different locking states I, II, III of a rotor shaft R of an electric-motor drive unit for driving a vehicle.

The electric-motor drive unit in this case comprises an electric motor, for instance in the form of a permanently excited or separately excited synchronous machine, and possibly a switchable reduction gear or speed reducer that is connected to the electric motor and accordingly boosts an electromotive torque. A locking device is in this case attached to a housing of the electric-motor drive unit and is supported by this housing.

The locking device in this case has a locking element VE and an electric drive for actuating the locking element VE, which electric drive is received by a housing of the locking device.

In or on the rotor shaft R, provision is made here for recesses A in which the locking element VE of correspondingly complementary design engages in order to lock the rotor shaft R (cf. locking states I, II, III).

In the locking states II, III, both static and dynamic torque loads of the drivetrain are introduced into the housing of the electric-motor drive unit via the illustrated locking mechanism.

The first locking state I in this case illustrates what is referred to as a central position of the locking element VE relative to the recess A, which needs to be taught to the vehicle system.

For this purpose, a lifting movement of the locking element VE is initiated by a controller or a controller, for instance by a controller of an inverter that is included as such in power electronics of the vehicle. The lifting movement may in this case be an axial lifting movement, that is to say a lifting movement of the locking element VE along a lifting axis into the recess A.

A sensor that monitors this locking process registers this lifting movement and reports it to the controller. The controller accordingly receives a sensor signal indicating a locking position of the locking element VE in the recess A. The rotor shaft R is thus locked.

The controller then initiates clockwise pivoting of the locked rotor shaft R until it comes to a first stop against or with the locking element VE and until a definable electromotive deactivation torque, at which the pivoting is interrupted (cf. locking state II), is reached. Said deactivation torque of the electric motor in this case corresponds to a monitorable current consumption of the electric motor, such that, when a definable reference value for the current consumption is reached, the electric motor is deactivated or the pivoting of the rotor shaft R is interrupted.

The controller then records and stores first electromotive angle information concerning the recess A, corresponding to the first stop.

The controller then initiates counterclockwise pivoting of the rotor shaft R until it comes to a second stop against or with the locking element VE and until said definable electromotive deactivation torque, at which the pivoting is interrupted again (cf. locking state III), is reached.

The controller then records and stores second electromotive angle information concerning the recess A, corresponding to the second stop.

The first and second angle information in this case together describe what is referred to as a free travel that the rotor shaft R is able to cover in the circumferential direction in which it is pivoted until it comes to a stop or one of the stops against or with the locking element VE.

Finally, the already previously mentioned central position of the recess A is ascertained from the first and second angle information.

What is referred to as a rotor (shaft) position sensor may be used to precisely determine a position or pose of a rotor of the electric motor and thus a position or pose of said rotor shaft R on which the rotor is arranged relative to the three phases or to the poles of a stator of the electric motor. The rotor (shaft) position sensor thus enables firstly efficient commutation of the electric motor and secondly determination of said first and second angle information with respect to said stops of the rotor shaft R against the locking element VE.

The rotor (shaft) position sensor may in this case be designed in the form of an inductive signal transmitter or in the form of a Hall transmitter, the operation of which is known sufficiently to a person skilled in the art.

The central position, thereby taught or learnt, of the recess A may be used to infer the individual central positions of the other recesses of the rotor shaft R to be locked. In addition or as an alternative, the central positions of the other recesses of the rotor shaft R may also be taught or learnt in the same way—or as described above.

These central positions are stored or saved in a memory of a controller in the sense of what are referred to as ideal positions—or also referred to as interpolation points—in order to be able to use them with software or a computer program for actuating or rotating the rotor shaft.

The proposed teaching method may in this case be initiated in response to a vehicle system request and/or in response to a driver request.

The teaching method described in this disclosure may be combined with various locking mechanisms of locking actuators. Reference may be made at this juncture for example to the German patent application with the application file number 10 2021 208 322.6 and to the German patent application with the application file number 10 2021 213 737.7, which each describe a parking lock having a locking member or locking element that is able to be adjusted or moved in a straight line along a movement path.

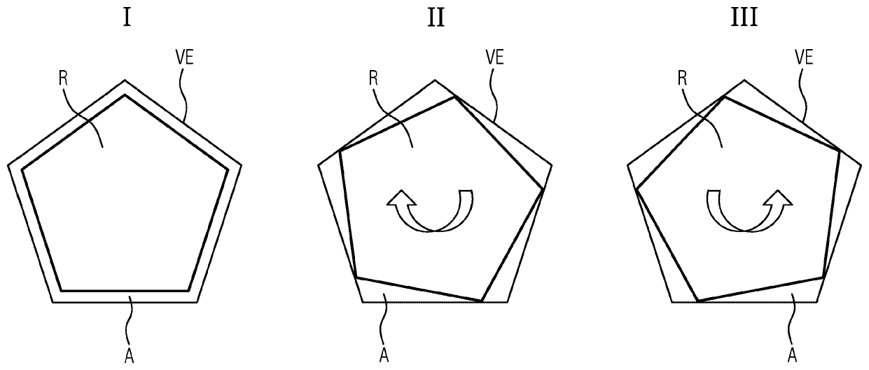

The locking mechanisms described in those two German patent applications may in this case be represented by the pentagons illustrated in FIG. 1 for simplification.

The German patent application with the application file number 10 2021 208 322.6 in this case describes a form-locking element of a locking actuator in the form of a locking bolt that is able to be moved or actuated in form-locking fashion, in a lifting movement along a lifting axis, into a recess of a rotatable element that is to be locked of a drivetrain.

The German patent application with the application file number 10 2021 213 737.7, by contrast, in this case describes a form-locking element of a locking actuator with a circumferential inner toothed mechanism, wherein the form-locking element is able to be moved or actuated, in an axial lifting movement and longitudinally to a lockable shaft, into a shaft section having an outer toothed mechanism of correspondingly complementary design.

In this case, the controller described above or the controller described above comprises a digital microprocessor unit (CPU) connected to a storage system and to a bus system for data transfer purposes, a random-access memory (RAM) and a storage means. In this case, the CPU is designed to process commands that are implemented as a program stored in a storage system, to acquire input signals from the data bus and to emit output signals to the data bus. The storage system may have various storage media in the form of magnetic, solid-state and other non-volatile media on which a corresponding computer program for performing the method and the advantageous embodiments is stored. The program may be designed such that it embodies or is capable of carrying out the method aspects described here such that the CPU is able to execute the steps of such methods and thus control both the vehicle and the parking lock or locking device.

A computer program having program code means for performing all of the steps of any of the claims or method claims when the program is executed in the CPU is suitable for performing the method.

In this case, the computer program may be read into pre-existing actuation electronics by way of simple means and used to control both the vehicle and the parking lock or locking device.

Provision is made for this purpose for a computer program product having program code means that are stored on a computer-readable data carrier in order to perform the method according to any of the claims when the computer program product is executed in the CPU. The computer program product may also be integrated into the actuation electronics as a retrofitted option.

Although exemplary embodiments are explained in the above description, it is pointed out that numerous modifications are possible. Furthermore, it is pointed out that the exemplary embodiments are only examples that are in no way intended to limit the scope of protection, the applications and the structure. Instead, the above description gives a person skilled in the art a guideline for implementing at least one exemplary embodiment, it being possible to make various changes, especially with regard to the function and arrangement of the component parts described, without departing from the scope of protection as will become apparent from the claims and combinations of features that are equivalent thereto.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-7. (canceled)

8. A method for teaching at least one locking position of a locking actuator relative to an element, which is to be locked and is configured to be driven by an electric motor, of a drivetrain of a vehicle, comprising:
initiating a lifting movement of a locking element of the locking actuator, along a lifting axis, into a recess of the element to be locked;
receiving a sensor signal indicating a locking position of the locking element in the recess;
initiating clockwise electromotive pivoting of the locked element until the locking element comes to a first stop against the locked element and interrupting the pivoting when a definable electromotive deactivation torque is reached;
receiving a first electromotive angle information concerning the recess, corresponding to the first stop;
initiating counterclockwise electromotive pivoting of the locked element until the locking element comes to a second stop against the locked element and interrupting the pivoting when the definable electromotive deactivation torque is reached;
receiving a second electromotive angle information concerning the recess, corresponding to the second stop; and
ascertaining electromotive angle information, corresponding to a central position of the recess, from the first electromotive angle information concerning the recess and the second electromotive angle information concerning the recess.

9. The method as claimed in claim 8, wherein the central position of the recess is used to infer individual central positions of other recesses of the element to be locked.

10. The method as claimed in claim 8, wherein the teaching method is initiated in response to a vehicle system request.

11. The method as claimed in claim 8, wherein the teaching method is initiated in response to a driver request.

12. A computer program stored on a nontransient computer readable medium configured to cause a computer to:
initiate a lifting movement of a locking element of a locking actuator, along a lifting axis, into a recess of an element to be locked;
receive a sensor signal indicating a locking position of the locking element in the recess;
initiate clockwise electromotive pivoting of the locked element until the locking element comes to a first stop against the locked element and interrupting the pivoting when a definable electromotive deactivation torque is reached;
receive a first electromotive angle information concerning the recess, corresponding to the first stop;
initiate counterclockwise electromotive pivoting of the locked element until the locking element comes to a second stop against the locked element and interrupting the pivoting when the definable electromotive deactivation torque is reached;
receive a second electromotive angle information concerning the recess, corresponding to the second stop; and
ascertain electromotive angle information, corresponding to a central position of the recess, from the first electromotive angle information concerning the recess and the second electromotive angle information concerning the recess.

13. The computer program of claim 12, wherein a vehicle comprises the computer program stored on a nontransient computer readable medium.

14. A computer program product, comprising program code means that are stored on a nontransient computer-readable data carrier in order to perform a method when the program code means are executed on a computer, comprising:
initiate a lifting movement of a locking element of a locking actuator, along a lifting axis, into a recess of an element to be locked;
receive a sensor signal indicating a locking position of the locking element in the recess;
initiate clockwise electromotive pivoting of the locked element until the locking element comes to a first stop against the locked element and interrupting the pivoting when a definable electromotive deactivation torque is reached;
receive a first electromotive angle information concerning the recess, corresponding to the first stop;
initiate counterclockwise electromotive pivoting of the locked element until the locking element comes to a second stop against the locked element and interrupting the pivoting when the definable electromotive deactivation torque is reached;
receive a second electromotive angle information concerning the recess, corresponding to the second stop; and
ascertain electromotive angle information, corresponding to a central position of the recess, from the first electromotive angle information concerning the recess and the second electromotive angle information concerning the recess.

15. The computer program product as claimed in claim 14, wherein a vehicle comprises the computer program product.
